(19) United States
(12) Patent Application Publication
(10) Pub. No.: US 2024/0191541 A1
(43) Pub. Date: Jun. 13, 2024

(54) LOCK ASSEMBLY

(71) Applicant: WENZHOU YUANFEI PET TOY PRODUCTS CO.,LTD., Wenzhou (CN)

(72) Inventor: Mingyun Zhuang, Wenzhou (CN)

(73) Assignee: WENZHOU YUANFEI PET TOY PRODUCTS CO.,LTD., Wenzhou (CN)

(21) Appl. No.: 18/105,262

(22) Filed: Feb. 3, 2023

(30) Foreign Application Priority Data
Dec. 12, 2022 (CN) 202211596968.6

(51) Int. Cl. E05B 15/04

(52) U.S. Cl. CPC E05B 15/04; E05B 2015/0424

(57) ABSTRACT

A locking assembly includes a mounting portion, a locking body, a resilient body, a toggle body, and a locking tongue, wherein the resilient body is disposed below the locking tongue, a cavity which may accommodate the resilient body and the locking tongue is provided in the mounting portion, the locking tongue may be driven by the toggle body to move toward the locking body along a central axis of the resilient body, wherein the locking tongue is engaged with the toggle body. The locking assembly has a simple structure with once-through power transmission to achieve a high transmission efficiency, greatly improved control accuracy and structural stability by transmission through engagement between the toggle body and the lock tongue, and simple way to control movement thereof, wherein the locking tongue is retracted when turned upward and is protruded when turned downward, thus to be closer to the user's habits.

### CROSS REFERENCE TO RELATED APPLICATIONS

This application claims the benefit of priority from Chinese Application No. 202211596968.6, filed Dec. 12, 2022, the entire contents of which are incorporated herein by reference.

### BACKGROUND

The present invention relates to the field of locks, and in particular to a lock assembly.

A lock assembly is widely used in the field of locks. The lock can be opened and closed by controlling the extension and contraction of the lock tongue. The most important evaluation standards for the lock assembly are its performance to prevent false touch and its reliability after locking. The lock assembly in the prior art mainly has the following issues: 1, the volume of the trigger part is always too large, which is prone to false touch: 2, the trigger part is often too concealed, which is not very convenient for the user's control of the lock tongue: 3, the mechanical control structure is often too complex and there is a transmission dead point: 4, after long-term use, due to wear and mechanical fatigue, its control accuracy decreases and it is not easy to replace new parts. Therefore, to find a balance between reliability and convenience and further simplify the transmission structure is the main issue of the lock assembly research and development.

### SUMMARY

The present embodiments beneficially provide a lock assembly, to eliminate the deficiencies of the prior art.

In accordance with an embodiment of the invention, a lock assembly comprises a mounting portion, a locking body, a resilient body, a toggle body and a lock tongue, wherein,
the resilient body is disposed below the lock tongue,
the toggle body may drive the lock tongue to move toward the lock body along a central axis of the resilient body,
a cavity, which may accommodate the resilient body and the lock tongue, is disposed in the mounting portion,
the lock tongue may be engaged with the toggle body, the lock tongue comprising: a tooth slot segment having a tooth slot surface, with the tooth slot surface provided with tooth slots; the toggle body comprising: an engagement surface and a toggle surface, with the engagement surface provided with cogs: wherein, the tooth slot surface engaging with the engagement surface.

The driving principle of the invention relies on that the toggle body drives the lock tongue to move along the central axis direction of the resilient body, so as to control the distance between the lock tongue and the lock body, thus, to realize movements of opening and closing. The lock tongue shrinks when the toggle body is moved upward, and protrudes when the toggle body is moved downward, both of which are longitudinal transformations, thus the control movement is simple and more in line with user's habits.

The resilient body in the invention can be in various forms, including of any hydraulic, pneumatic, mechanical transmission, electric and other power generation methods that can realize springback. However, it is necessary to ensure that the resilient body maintains a certain amount of elastic potential energy when the lock tongue is closed and opened, that is, to ensure that the resilient body is always under pressure. Even when the lock tongue is fully extended to close the lock body, the stored elastic potential energy in the resilient body can fully ensure that the contact between the top of the lock tongue and the bottom of the lock body is tight and reliable.

In more extreme cases, when the locking relationship between the lock tongue and the toggle body fails, the resilient body can still rely on its own resilience to ensure the closure of the lock tongue and the lock body.

Similarly, due to the existence of resilient body, users can get good experience in touch and rebound when they toggle the lock tongue, which is convenient for them to confirm the position of the lock tongue.

Preferably, a transition surface is arranged between the engagement surface and the toggle surface, the transition surface comprises:
a first transition surface, which is a surface between a last cog and its adjacent toggle surface, the last cog being the last wheel tooth engaged with the tooth slot at the lowermost end of the tooth slot segment.
a second transition surface, which is a surface between a first tooth and its adjacent toggle surface, the first cog referring to the, the first cog being the wheel tooth farthest from the last cog.
there being no interference with between the first transition surface and the resilient body.

In order to reduce the collision of parts and prevent the occurrence of the dead point of the mechanism, the first transition surface mentioned above will not interfere with the resilient body below, so the first transition surface can be an inclined surface, an inner concave surface and any convex arc surface that does not collide with the resilient body.

Preferably, the lock tongue further comprises a step section and a lock segment, the step segment being provided at the lower end of the tooth slot segment and the lock segment being provided at the upper end of the tooth slot segment, the step segment providing longitudinal restriction of the resilient body.

Different locks have different opening sizes of lock body, which also determines the length of the locking segment, the length of the locking segment only needs to be not less than the opening size of the lock body to meet the locking requirements, but considering the possible extrusion wear at the head end of the lock segment in long-term use and multiple cogs and tooth slots provided by the present invention, the locking segment can be adjusted with its extension length through toggle body's cog, so one can consider extending an appropriate amount of the length of the lock segment.

In case that the locked object is large, the lock body requires a large opening, which is far away from the lock tongue, and the extension of the locking segment is also large. In this application, the lock segment is prone to lateral bending stress and shear force when locked. On the one hand, if the material stiffness of the lock segment is not rigid, the positional shift, i.e., the misalignment of the lock segment with the lock body and the bending deformation of the lock segment can easily occur at the abutment surface. In addition, even if the material rigidity of the lock segment is excellent, if the bending stress is too large, the lock segment can easily break. In summary, a variety of factors will affect the reliability of locking in many ways. Therefore, if the locking assembly needs to be used in such environment for a long time, one can consider extending a length at the head of the locking segment with a convex head. Similarly, one may open a concave seat at the position of the lock body butting with the lock segment, so that the convex head will be recessed in the concave seat after locking, to fix both ends of the locking segment, thus the locking reliability is greatly improved.

Preferably, the outer surface of the tooth slot segment is provided with a limiting structure, and the inner wall of the cavity is provided with a chute adapted to the limit structure. The limit structure extends longitudinally along the outer surface of the tooth slot segment and may be contained in the chute to limit the movement of the lock tongue, thus to ensure the lock tongue will not shift circumferentially when moving along the central axis of the resilient body.

The movement of the lock tongue is essentially achieved by the movement of the tooth slot segment, which is an important precision-keeping structure in the parts of the present invention because it engages with the engagement surface and often needs to be contained or housed in the mounting portion 17 for protection, so it is not destined to be disassembled and calibrated frequently, so in order to ensure that the cog and the tooth slot are not misaligned, the movement of the tooth slot segment needs to be maintained at a fixed center axis at all times. The limiting structure of the present invention is applied for this purpose, ensuring that the limiting structure can only move in a fixed chute, thus indirectly enabling the movement of the tooth slot segment always in the direction of the central axis without the need for calibration.

Preferably, the limiting structure is a convex rail.

The number of the convex rail preferably be more than one. When only one rail is provided, it is easy to wear out and flatten due to long-term stress depending on one rail, eventually affecting the limiting effect.

Preferably, the resilient body is a spring, the step segment is a spring seat, and the spring is sleeved on the spring seat.

The spring is of the simplest technical scheme for the resilient body of the invention, which has low cost and can be widely used in simple and small lock applications. The invention adopts the positioning mode of the spring sleeved on the spring seat to facilitate the disassembly and replacement after spring fatigue failure later.

Preferably, a chamfer is arranged at the shaft shoulder between the step segment and the tooth slot segment, and the limiting structure extends to the chamfer.

The chamfer at the shoulder provides positioning for the resilient body and makes the lock tongue retract more smoothly. The limiting structure extends to the chamfer, which allows the tooth slot segment and the step segment have a smooth transition, thus greatly reduces the stress concentration at the shoulder position caused by the spring impact during the lock tongue sliding process, consequently lengthening the service life of the structure.

Preferably, the tooth width of the tooth slot is not less than the tooth width of the cog.

In order to ensure the accuracy of the engagement, as well as to comply with the principle of reducing the volume of the trigger structure against false touches, the width of the cog is suitably not too wide.

Preferably, the toggle surface is provided with a toggle edge, and the full height of the cog is not less than that of the toggle edge.

The presence of the toggle edge acts as an anti-slip structure when the user activates the structure, and the presence of the cog is such that dynamic actuation is achieved in their engagement with the tooth slots, where the surface of the cog is where the force is most concentrated throughout the structure of the present invention and where fatigue wear is most likely to occur. Considering for possible wear in the future, the full height of the cog is suitably not too small, instead it should be as large as volume permits, and the height of the toggle edge is suitably not too large, as long as the basic anti-slip requirements to be met. Further, if the height of the toggle edge is too large, it will cause the user to feel a noticeable misbehaving contact with the skin, not complying with human and functional industrial design principles.

Preferably, the spring is a middle convex coil spring with a diameter of the coil decreasing toward both ends.

If the spring is used as the resilient body of the invention, the middle convex coil spring is more preferred. The application of the spring as the resilient body of the invention is often in the case of the lock itself with small volume, which means that the installation space left for the spring in the installation part is limited. In order to maximize the compression resilience when the axial space is limited, the nonlinear characteristics of the middle convex coil spring fully demonstrate its absolute advantages over the linear spring, with varied density, flexible elastic coefficient, and changing stiffness along with the displacement. The greater the deformation of the middle convex coil spring, the greater the stiffness. With the aggravation of the deformation, more pressure is needed to deform it. Therefore, when the toggle pressure is the same, the deformation of the middle convex coil spring is smaller, with smaller need for installation space, and more available height of the spring.

In addition, the special shape of the narrow ends of the middle convex coil spring also greatly reduces the possibility of collision and interference with the first transition surface in the invention.

Techniques of the present invention can provide substantial beneficial technical effects. By way of example only and without limitation, a lock assembly according to one or more embodiments of the invention may provide one or more of the following advantages:
the locking assembly has a simple structure with once-through power transmission to achieve a high transmission efficiency, greatly improved control accuracy and structural stability;
by transmission through engagement between the toggle body and the lock tongue, and simple way to control movement thereof, wherein the locking tongue is retracted when turned upward and is protruded when turned downward, thus to be closer to the user's habits;
the volume of the toggle body relative to the lock tongue is as small as possible without compromising the convenience of use, obtaining the optimal balance between the anti false-touch and operability;
the invention fully considers the smooth transmission and stress analysis between each part, so that there is no structural dead point and part interference, and greatly improves the service life.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a schematic view depicting the overall structure of an exemplary embodiment of the present invention.

FIG. 2 is a perspective view depicting an exemplary embodiment of the present invention.

FIG. 3 is a schematic view depicting the internal structure according to an exemplary embodiment of the present invention.

FIG. 4 is an front view depicting the internal structure according to an exemplary embodiment of the present invention.

The reference numerals are illustrated as follows:
1-lock segment; 2-tooth slot segment; 3-step segment; 4-toggle body; 5-toggle surface; 6-engagement surface; 7-first transition surface; 8-second transition surface; 9-resilient body; 10-tooth slot; 11-cog; 12-toggle edge; 13-convex rail; 14-chamfer; 15-shaft pin; 16-lock body; 17-mounting portion; 18-chute; 19-lock tongue; 20-ear plate.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Various aspects of the disclosure are further detailed below.

Unless defined otherwise, all technical and scientific terms used herein have the same meaning as commonly understood by one of ordinary skill in the art. Moreover, any method and material similar or equivalent to those described may be used in the present disclosure.

The terms are described as below.

Unless defined otherwise, “or” as used herein includes a relationship of “and”. The “sum” corresponds to a Boolean logic operator “AND,” which corresponds to a Boolean logic operator “OR,” and “AND” is a subset of “OR”.

The terminology used herein is for the purpose of describing particular embodiment only and is not intended to be limiting of the present disclosure. As used herein, the singular forms “a,” “an,” and “the” may include the plural forms as well, unless the context clearly indicates otherwise. Further, the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “above.” “below.” “above.” and “below” are used to indicate relative positional relationships between elements or structures, rather than absolute positions.

The implementations of the present disclosure are illustrated below through specific examples, and other advantages and effects of the present disclosure can be easily understood by those skilled in the art through the contents disclosed in the description of the present disclosure. Apparently, the described embodiments are only a part but not all of the embodiments of the present disclosure. The present disclosure can also be implemented or applied by further different specific implementations. Moreover, various modifications or changes may be made to all details in this description based on different viewpoints and applications without departing from the spirit of the present disclosure. It should be noted that the following embodiments and features therein may be combined with each other without conflict. All other embodiments obtained by a person of ordinary skill in the art based on the embodiments of the present disclosure without creative efforts shall fall within the protection scope of the present disclosure.

It should be noted that the diagrams provided in the following embodiments merely schematically illustrate the basic concept of the present disclosure, and only the components related to the present disclosure are shown in the diagrams, so that the diagrams are not drawn in accordance with the number, shape and size of the components in actual implementations. The type, the number and the proportion of the components in the actual implementations can be arbitrarily changed, and layouts of the components may be more complicated.

In addition, in the following description, specific details are provided to facilitate thorough understanding of the examples. However, it will be understood by those skilled in the art that the described aspects may be practiced without these specific details.

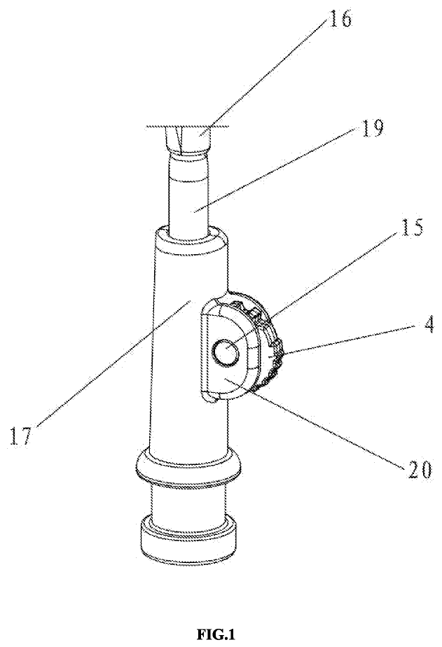

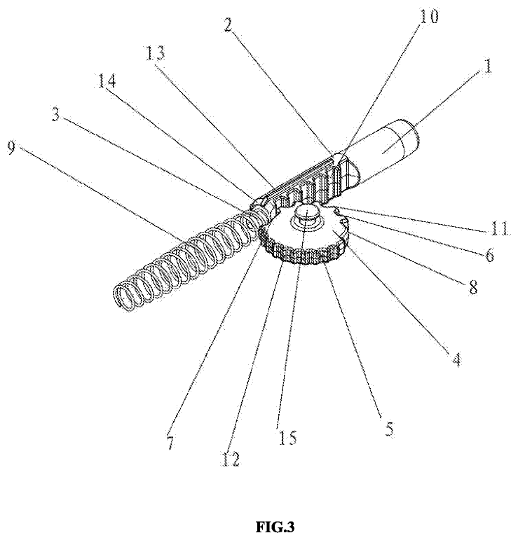

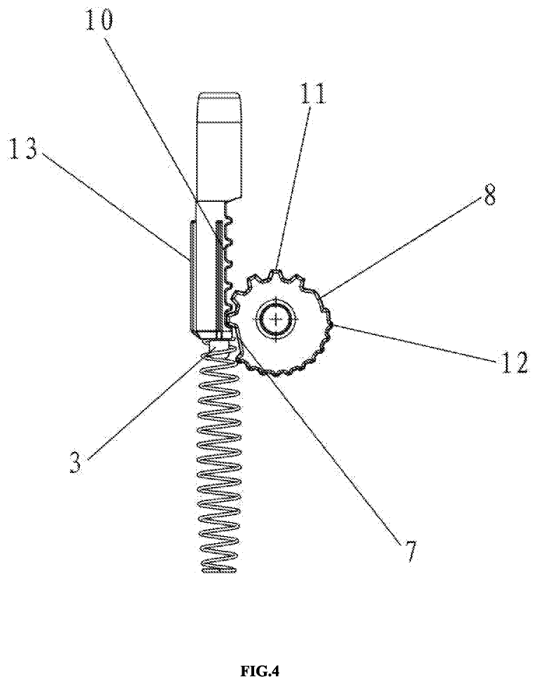

As shown in FIGS. 1-4, the present embodiments provides a lock assembly, comprises a mounting portion 17, a locking body 16, a resilient body 9, a toggle body 4 and a lock tongue 9, the resilient body 9 is disposed below the lock tongue 19, the toggle body 4 may drive the lock tongue 19 to move toward the lock body 16 along a central axis of the resilient body, a cavity being disposed in the mounting portion 17, the cavity capable of accommodating the resilient body 9 and the lock tongue 19, the lock tongue 19 capable of being engaged with the toggle body 4, the lock tongue 19 comprising a tooth slot segment 2 having a tooth slot surface, with the tooth slot surface provided with tooth slots 10; the toggle body 4 comprising an engagement surface 6 and a toggle surface 5, with the engagement surface provided with cogs 11: wherein, the tooth slot surface engaging with the engagement surface 6.

The driving principle of the invention relies on that the toggle body 4 drives the lock tongue 19 to move along the central axis direction of the resilient body 9, so as to control the distance between the lock tongue 19 and the lock body 16, thus to realize movements of opening and closing. The lock tongue 19 shrinks when the toggle body is moved upward, and protrudes when the toggle body is moved downward, both of which are longitudinal transformations, thus the control movement is simple and more in line with user's habits.

The resilient body 9 in the invention can be in various forms, including of any hydraulic, pneumatic, mechanical transmission, electric and other power generation methods that can realize springback. However, it is necessary to ensure that the resilient body maintains a certain amount of elastic potential energy when the lock tongue 19 is closed and opened, that is, to ensure that the resilient body is always under pressure. Even when the lock tongue 19 is fully extended to close the lock body 16, the stored elastic potential energy in the resilient body can fully ensure that the contact between the top of the lock tongue 19 and the bottom of the lock body 16 is tight and reliable.

In more extreme cases, when the locking relationship between the lock tongue 19 and the toggle body 4 fails, the resilient body 9 can still rely on its own resilience to ensure the closure of the lock tongue and the lock body.

Similarly, due to the existence of resilient body 9, users can get good experience in touch and rebound when they toggle the lock tongue 19, which is convenient for them to confirm the position of the lock tongue 19.

A transition surface is arranged between the engagement surface and the toggle surface 5, the transition surface comprises: a first transition surface 7, which is an surface between an last cog and its adjacent toggle surface 5, the last cog being the last wheel tooth 11 engaged with the tooth slot 10 at the lowermost end of the tooth slot segment 2: a second transition surface 8, which is an surface between a first tooth and its adjacent toggle surface 5, the first cog referring to the, the first cog being the wheel tooth 11 farthest from the last cog, there being no interference with between the first transition surface 7 and the resilient body 9.

In order to reduce the collision of parts and prevent the occurrence of the dead point of the mechanism, the first transition surface 7 mentioned above will not interfere with the resilient body 9 below, so the first transition surface 7 can be an inclined surface, an inner concave surface and any convex arc surface that does not collide with the resilient body 9.

Preferably, the lock tongue 19 further comprises a step section 3 and a lock segment 1, the step segment 3 being provided at the lower end of the tooth slot segment 2 and the lock segment 1 being provided at the upper end of the tooth slot segment 2, the step segment 3 providing longitudinal restriction of the resilient body 9.

Different locks have different opening sizes of lock body 16, which also determines the length of the locking segment 1, the length of the locking segment 1 only needs to be not less than the opening size of the lock body 16 to meet the locking requirements, but considering the possible extrusion wear at the head end of the lock segment 1 in long-term use and multiple cogs 11 and tooth slots 10 provided by the present invention, the locking segment 1 can be adjusted with its extension length through toggle body 4's cogs 11, so one can consider extending an appropriate amount of the length of the lock segment 1.

In case that the locked object is large, the lock body 16 requires a large opening, and the extension of the locking segment 1 is also large. In this application, the lock segment 1 is prone to lateral bending stress and shear force when locked. On the one hand, if the material stiffness of the lock segment 1 is not rigid, the positional shift, i.e., the misalignment of the lock segment 1 with the lock body 16 and the bending deformation of the lock segment 1 can easily occur at the abutment surface. In addition, even if the material rigidity of the lock segment 1 is excellent, if the bending stress is too large, the lock segment 1 can easily break. In summary, a variety of factors will affect the reliability of locking in many ways. Therefore, if the locking assembly needs to be used in such environment for a long time, one can consider extending a length at the head of the locking segment 1 with a convex head. Similarly, one may open a concave seat at the position of the lock body 16 butting with the lock segment 1, so that the convex head will be recessed in the concave seat after locking, to fix both ends of the locking segment 1, thus the locking reliability is greatly improved.

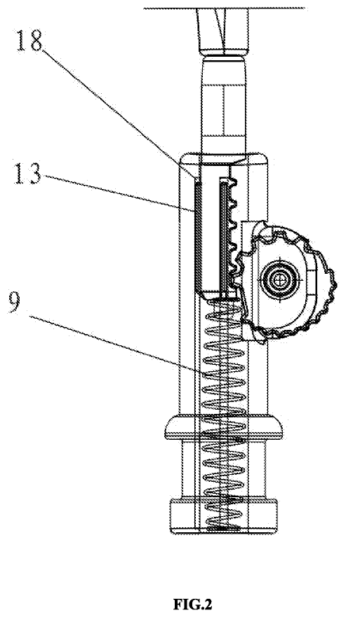

As shown in FIG. 2, the outer surface of the tooth slot segment 2 is provided with a limiting structure, and the inner wall of the cavity is provided with a chute 18 adapted to the limit structure. The limit structure extends longitudinally along the outer surface of the tooth slot segment 2 and may be contained in the chute 18 to limit the movement of the lock tongue 19, thus to ensure the lock tongue 19 will not shift circumferentially when moving along the central axis of the resilient body 9.

The movement of the lock tongue 19 is essentially achieved by the movement of the tooth slot segment 2, which is an important precision-keeping structure in the parts of the present invention because it engages with the engagement surface 6 and often needs to be contained or housed in the mounting portion 17 for protection, so it is not destined to be disassembled and calibrated frequently, so in order to ensure that the cog 11 and the tooth slot 10 are not misaligned, the movement of the tooth slot segment 2 needs to be maintained at a fixed center axis at all times. The limiting structure of the present invention is applied for this purpose.

The limiting structure is a convex rail 13. The number of the convex rail 13 preferably be more than one. When only one rail 13 is provided, it is easy to wear out and flatten due to long-term stress depending on one rail, eventually affecting the limiting effect.

The resilient body 9 is a spring, the step segment 3 is a spring seat, and the spring is sleeved on the spring seat.

The spring is of the simplest technical scheme for the resilient body 9 of the invention, which has low cost and can be widely used in simple and small lock applications. The invention adopts the positioning mode of the spring sleeved on the spring seat to facilitate the disassembly and replacement after spring fatigue failure later.

A chamfer 14 is arranged at the shaft shoulder between the step segment 3 and the tooth slot segment 2, and the limiting structure extends to the chamfer.

The chamfer 14 at the shoulder provides positioning for the resilient body 9 and also makes the lock tongue 19 retract more smoothly. The limiting structure extends to the chamfer 14, which allows the tooth slot segment 2 and the step segment 2 have a smooth transition, thus greatly reduces the stress concentration at the shoulder position caused by the spring impact during the lock tongue 19 sliding process, consequently lengthening the service life of the structure.

The tooth width of the tooth slot 10 is not less than the tooth width of the cog 11.

In order to ensure the accuracy of the engagement, as well as to comply with the principle of reducing the volume of the trigger structure against false touches, the width of the cog 11 is suitably not too wide.

The toggle surface 5 is provided with a toggle edge 12, and the full height of the cog 11 is not less than that of the toggle edge 12.

The presence of the toggle edge 12 acts as an anti-slip structure when the user activates the structure, and the presence of the cog 11 is such that dynamic actuation is achieved in their engagement with the tooth slots 10, where the surface of the cog 11 is where the force is most concentrated throughout the structure of the present invention and where fatigue wear is most likely to occur. Considering for possible wear in the future, the full height of the cog 11 is suitably not too small, instead it should be as large as volume permits, and the height of the toggle edge 12 is suitably not too large, as long as the basic anti-slip requirements to be met. Further, if the height of the toggle edge 12 is too large, it will cause the user to feel a noticeable misbehaving contact with the skin, not complying with human and functional industrial design principles.

The spring is a middle convex coil spring with a diameter of the coil decreasing toward both ends.

If the spring is used as the resilient body 9 of the invention, the middle convex coil spring is more preferred. The application of the spring as the resilient body 9 of the invention is often in the case of the lock itself with small volume, which means that the installation space left for the spring in the installation part is limited. In order to maximize the compression resilience when the axial space is limited, the nonlinear characteristics of the middle convex coil spring fully demonstrate its absolute advantages over the linear spring, with varied density, flexible elastic coefficient, and changing stiffness along with the displacement. The greater the deformation of the middle convex coil spring, the greater the stiffness. With the aggravation of the deformation, more pressure is needed to deform it. Therefore, when the toggle pressure is the same, the deformation of the middle convex coil spring is smaller, with smaller need for installation space, and more available height of the spring.

In addition, the special shape of the narrow ends of the middle convex coil spring also greatly reduces the possibility of collision and interference with the first transition surface 7 in the invention.

Pin hole is opened at the toggle body 4, and a pin shaft 15 runs through the pin hole. The pin shaft 15 is installed in a fixed position, and the fixed position here can be the mounting portion 17. For example, in FIG. 1, the pin shaft 15 is fixed by setting an ear plate 20 on the side of the mounting portion 17, and it can also be other external structures separated from the invention. As long as the engagement between the installed cog 11 and the tooth slot 10 is ensured, when the lock assembly is operating, the engagement position between the cog 11 and the tooth slot 10 is controlled by toggling the toggle edge 12, thereby adjusting the extension amount of the lock segment 1 and controlling its relative distance from the lock body 16 to realize the opening and closing of the lock. When the lock segment 1 shrinks, the lower resilient body 9 is compressed by pressure. When the lock segment 1 protrudes, the resilient body 9 is also kept under pressure, so that there is a certain amount of rebound when the lock is opened and closed, to ensure that the end face of the lock segment 1 and the contact surface of the lock body 16 are closely fitted during locking, ensuring the reliability of the lock.

The illustrations of embodiments of the invention described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein: other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

The corresponding structures, materials, acts, and equivalents of all means or step-plus-function elements in the claims below are intended to include any structure, material, or act for performing the function in combination with other claimed elements as specifically claimed. The description of the various embodiments has been presented for purposes of illustration and description but is not intended to be exhaustive or limited to the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the various embodiments with various modifications as are suited to the particular use contemplated.

The abstract is provided to comply with 37 C.F.R. § 1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus, the following claims are hereby incorporated into the Detailed Description, with each claim standing on its own as separately claimed subject matter.

The foregoing descriptions merely refer to the specific embodiments of the present disclosure, but the protection scope of the present disclosure is not limited thereto. Variations or modifications that can be made easily by those skilled in the art should fall within the protection scope of the present disclosure. Therefore, the protection scope of the present disclosure shall be subject to the protection scope of the claims.

What is claimed is:

1. A lock assembly comprising a mounting portion, a locking body, a resilient body, a toggle body and a lock tongue, wherein,
the resilient body is disposed below the lock tongue,
the toggle body capable of driving the lock tongue to move toward the lock body along a central axis of the resilient body,
a cavity, capable of accommodating the resilient body and the lock tongue, is disposed in the mounting portion,
the lock tongue capable of being engaged with the toggle body, the lock tongue comprising: a tooth slot segment having a tooth slot surface, with the tooth slot surface provided with tooth slots;
the toggle body comprising: an engagement surface and a toggle surface, with the engagement surface provided with cogs.
wherein, the tooth slot surface engaging with the engagement surface.

2. The lock assembly according to claim 1, wherein,
a transition surface is arranged between the engagement surface and the toggle surface, the transition surface comprising:
a first transition surface, which is a surface between a last cog and its adjacent toggle surface, the last cog being the last wheel tooth engaged with the tooth slot at the lowermost end of the tooth slot segment,
a second transition surface, which is a surface between a first tooth and its adjacent toggle surface, the first cog referring to the, the first cog being the wheel tooth farthest from the last cog,
there being no interference with between the first transition surface and the resilient body.

3. The lock assembly according to claim 1, wherein,
the lock tongue further comprises a step segment and a lock segment,
the step segment being provided at the lower end of the tooth slot segment and the lock segment being provided at the upper end of the tooth slot segment, the step segment providing longitudinal restriction of the resilient body.

4. The lock assembly according to claim 3, wherein,
the outer surface of the tooth slot segment is provided with a limiting structure, and the inner wall of the cavity is provided with a chute adapted to the limit structure,
the limit structure extending longitudinally along the outer surface of the tooth slot segment and capable of being contained in the chute to limit the movement of the lock tongue, thus to ensure the lock tongue will not shift circumferentially when moving along the central axis of the resilient body.

5. The lock assembly according to claim 4, wherein, the limiting structure is a convex rail.

6. The lock assembly according to claim 3, wherein, the resilient body is a spring, the step segment being a spring seat, and the spring being sleeved on the spring seat.

7. The lock assembly according to claim 4, wherein, the resilient body is a spring, the step segment being a spring seat, and the spring being sleeved on the spring seat.

8. The lock assembly according to claim 5, wherein, the resilient body is a spring, the step segment being a spring seat, and the spring being sleeved on the spring seat.

9. The lock assembly according to claim 3, wherein, a chamfer is arranged at the shaft shoulder between the step segment and the tooth slot segment, and the limiting structure extending to the chamfer.

10. The lock assembly according to claim 4, wherein, a chamfer is arranged at the shaft shoulder between the step segment and the tooth slot segment, and the limiting structure extending to the chamfer.

11. The lock assembly according to claim 5, wherein, a chamfer is arranged at the shaft shoulder between the step segment and the tooth slot segment, and the limiting structure extending to the chamfer.

12. The lock assembly according to claim 1, wherein, the tooth width of the tooth slot is not less than the tooth width of the cog.

13. The lock assembly according to claim 2, wherein, the tooth width of the tooth slot is not less than the tooth width of the cog.

14. The lock assembly according to claim 3, wherein, the tooth width of the tooth slot is not less than the tooth width of the cog.

15. The lock assembly according to claim 4, wherein, the tooth width of the tooth slot is not less than the tooth width of the cog.

16. The lock assembly according to claim 5, wherein, the tooth width of the tooth slot is not less than the tooth width of the cog.

17. The lock assembly according to claim 1, wherein, the toggle surface is provided with a toggle edge, and the full height of the cog being not less than that of the toggle edge.

18. The lock assembly according to claim 5, wherein, the toggle surface is provided with a toggle edge, and the full height of the cog being not less than that of the toggle edge.

19. The lock assembly of claim 17, wherein, the spring is a middle convex coil spring with a diameter of the coil decreasing toward both ends.

20. The lock assembly according to claim 18, wherein, the spring is a middle convex coil spring with a diameter of the coil decreasing toward both ends.
